(19) United States
(12) Patent Application Publication
(10) Pub. No.: US 2026/0162394 A1
(43) Pub. Date: Jun. 11, 2026

(54) PROCESSING IMAGE DATA

(71) Applicant: QUALCOMM Incorporated, San Diego, CA (US)

(72) Inventors: Saurabh Ramesh GANGURDE, Bangalore (IN); Amrit Anand AMRESH, Bangalore (IN); Prasant Shekhar SINGH, Bangalore (IN)

(21) Appl. No.: 18/976,164

(22) Filed: Dec. 10, 2024

(51) Int. Cl. G06V 10/25; G06F 3/01

(52) U.S. Cl. CPC G06V 10/25; G06F 3/013

(57) ABSTRACT

Systems and techniques are described herein for processing image data. For instance, a method for processing image data is provided. The method may include determining a first region of interest (ROI) for first image data based on gaze data; providing an indication of the first ROI to an image processor; processing, using the image processor, the first image data based on the first ROI; predicting a second ROI for second image data based on the gaze data; providing an indication of the second ROI to an image sensor; and capturing, using the image sensor, the second image data based on the second ROI.

### TECHNICAL FIELD

The present disclosure generally relates to processing image data. For example, aspects of the present disclosure include systems and techniques for processing image data based on a region of interest.

### BACKGROUND

Extended reality (XR) technologies can be used to present virtual content to users, and/or can combine real environments from the physical world and virtual environments to provide users with XR experiences. The term XR can encompass virtual reality (VR), augmented reality (AR), mixed reality (MR), and the like. XR systems can allow users to experience XR environments by overlaying virtual content onto a user's view of a real-world environment. For example, an XR head-mounted device (HMD) may include a display that allows a user to view the user's real-world environment through a display of the HMD (e.g., a transparent display). The XR HMD may display virtual content at the display in the user's field of view overlaying the user's view of their real-world environment. Such an implementation may be referred to as “see-through” XR. As another example, an XR HMD may include a scene-facing camera that may capture images of the user's real-world environment. The XR HMD may modify or augment the images (e.g., adding virtual content) and display the modified images to the user. Such an implementation may be referred to as “pass through” XR or as “video see through (VST).” The user can generally change their view of the environment interactively, for example by tilting or moving the XR HMD.

A foveated image is an image with different resolutions in different regions within the image. For example, a foveated image may include a highest resolution in a region of interest (ROI) and one or more lower-resolution regions around the ROI (e.g., in one or more “peripheral regions”).

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for processing image data. According to at least one example, a method is provided for processing image data. The method includes: determining a first region of interest (ROI) for first image data based on gaze data; providing an indication of the first ROI to an image processor; processing, using the image processor, the first image data based on the first ROI; predicting a second ROI for second image data based on the gaze data; providing an indication of the second ROI to an image sensor; and capturing, using the image sensor, the second image data based on the second ROI.

In another example, an apparatus for processing image data is provided that includes at least one memory and at least one processor (e.g., configured in circuitry) coupled to the at least one memory. The at least one processor configured to: determine a first region of interest (ROI) for first image data based on gaze data; provide an indication of the first ROI to an image processor; process, using the image processor, the first image data based on the first ROI; predict a second ROI for second image data based on the gaze data; provide an indication of the second ROI to an image sensor; and capture, using the image sensor, the second image data based on the second ROI.

In another example, a non-transitory computer-readable medium is provided that has stored thereon instructions that, when executed by one or more processors, cause the one or more processors to: determine a first region of interest (ROI) for first image data based on gaze data; provide an indication of the first ROI to an image processor; process, using the image processor, the first image data based on the first ROI; predict a second ROI for second image data based on the gaze data; provide an indication of the second ROI to an image sensor; and capture, using the image sensor, the second image data based on the second ROI.

In another example, an apparatus for processing image data is provided. The apparatus includes: means for determining a first region of interest (ROI) for first image data based on gaze data; means for providing an indication of the first ROI to an image processor; means for processing, using the image processor, the first image data based on the first ROI; means for predicting a second ROI for second image data based on the gaze data; means for providing an indication of the second ROI to an image sensor; and means for capturing, using the image sensor, the second image data based on the second ROI.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating an example extended-reality (XR) system, according to aspects of the disclosure;

FIG. 2 includes a representation of an example foveated image, according to various aspects of the present disclosure;

FIG. 3 is a block diagram illustrating an example system for processing foveated image data, according to various aspects of the present disclosure;

FIG. 4 is a block diagram illustrating an example system for processing foveated image data, according to various aspects of the present disclosure;

FIG. 5 includes an illustration of an example foveated image, according to various aspects of the present disclosure;

FIG. 6 is a block diagram illustrating an example system for processing foveated image data, according to various aspects of the present disclosure;

FIG. 7 is a block diagram illustrating an example implementation of the image processor of FIG. 6, according to various aspects of the present disclosure;

FIG. 8 is a timing diagram illustrating an example process for processing foveated image data;

FIG. 9 is a timing diagram illustrating an example process for processing foveated image data, according to various aspects of the present disclosure;

FIG. 10 is a block diagram illustrating an example system for processing foveated image data, according to various aspects of the present disclosure;

FIG. 11 is a timing diagram illustrating an example process for processing foveated image data, according to various aspects of the present disclosure;

FIG. 12 is a flow diagram illustrating an example process for processing image data, in accordance with aspects of the present disclosure;

FIG. 13 is a block diagram illustrating an example of a deep learning neural network that can be used to perform various tasks, according to some aspects of the disclosed technology;

FIG. 14 is a block diagram illustrating an example of a convolutional neural network (CNN), according to various aspects of the present disclosure; and

FIG. 15 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As noted previously, an extended reality (XR) system or device can provide a user with an XR experience by presenting virtual content to the user (e.g., for a completely immersive experience) and/or can combine a view of a real-world or physical environment with a display of a virtual environment (made up of virtual content). The real-world environment can include real-world objects (also referred to as physical objects), such as people, vehicles, buildings, tables, chairs, and/or other real-world or physical objects. As used herein, the terms XR system and XR device are used interchangeably. Examples of XR systems or devices include head-mounted displays (HMDs) (which may also be referred to as a head-mounted devices), XR glasses (e.g., AR glasses, MR glasses, etc.) (also referred to as smart or network-connected glasses), among others. In some cases, XR glasses are an example of an HMD. In some cases, an XR system can track parts of the user (e.g., a hand and/or fingertips of a user) to allow the user to interact with items of virtual content.

XR systems can include virtual reality (VR) systems facilitating interactions with VR environments, augmented reality (AR) systems facilitating interactions with AR environments, mixed reality (MR) systems facilitating interactions with MR environments, and/or other XR systems.

For instance, VR provides a complete immersive experience in a three-dimensional (3D) computer-generated VR environment or video depicting a virtual version of a real-world environment. VR content can include VR video in some cases, which can be captured and rendered at very high quality, potentially providing a truly immersive virtual reality experience. Virtual reality applications can include gaming, training, education, sports video, online shopping, among others. VR content can be rendered and displayed using a VR system or device, such as a VR HMD or other VR headset, which fully covers a user's eyes during a VR experience.

AR is a technology that provides virtual or computer-generated content (referred to as AR content) over the user's view of a physical, real-world scene or environment. AR content can include virtual content, such as video, images, graphic content, location data (e.g., global positioning system (GPS) data or other location data), sounds, any combination thereof, and/or other augmented content. An AR system or device is designed to enhance (or augment), rather than to replace, a person's current perception of reality. For example, a user can see a real stationary or moving physical object through an AR device display, but the user's visual perception of the physical object may be augmented or enhanced by a virtual image of that object (e.g., a real-world car replaced by a virtual image of a DeLorean), by AR content added to the physical object (e.g., virtual wings added to a live animal), by AR content displayed relative to the physical object (e.g., informational virtual content displayed near a sign on a building, a virtual coffee cup virtually anchored to (e.g., placed on top of) a real-world table in one or more images, etc.), and/or by displaying other types of AR content. Various types of AR systems can be used for gaming, entertainment, and/or other applications.

MR technologies can combine aspects of VR and AR to provide an immersive experience for a user. For example, in an MR environment, real-world and computer-generated objects can interact (e.g., a real person can interact with a virtual person as if the virtual person were a real person).

An XR environment can be interacted with in a seemingly real or physical way. As a user experiencing an XR environment (e.g., an immersive VR environment) moves in the real world, rendered virtual content (e.g., images rendered in a virtual environment in a VR experience) also changes, giving the user the perception that the user is moving within the XR environment. For example, a user can turn left or right, look up or down, and/or move forwards or backwards, thus changing the user's point of view of the XR environment. The XR content presented to the user can change accordingly, so that the user's experience in the XR environment is as seamless as it would be in the real world.

In some cases, an XR system can match the relative pose and movement of objects and devices in the physical world. For example, an XR system can use tracking information to calculate the relative pose of devices, objects, and/or features of the real-world environment in order to match the relative position and movement of the devices, objects, and/or the real-world environment. In some examples, the XR system can use the pose and movement of one or more devices, objects, and/or the real-world environment to render content relative to the real-world environment in a convincing manner. The relative pose information can be used to match virtual content with the user's perceived motion and the spatio-temporal state of the devices, objects, and real-world environment. In some cases, an XR system can track parts of the user (e.g., a hand and/or fingertips of a user) to allow the user to interact with items of virtual content.

XR systems or devices can facilitate interaction with different types of XR environments (e.g., a user can use an XR system or device to interact with an XR environment). One example of an XR environment is a metaverse virtual environment. A user may virtually interact with other users (e.g., in a social setting, in a virtual meeting, etc.), virtually shop for items (e.g., goods, services, property, etc.), to play computer games, and/or to experience other services in a metaverse virtual environment. In one illustrative example, an XR system may provide a 3D collaborative virtual environment for a group of users. The users may interact with one another via virtual representations of the users in the virtual environment. The users may visually, audibly, haptically, or otherwise experience the virtual environment while interacting with virtual representations of the other users.

A virtual representation of a user may be used to represent the user in a virtual environment. A virtual representation of a user is also referred to herein as an avatar. An avatar representing a user may mimic an appearance, movement, mannerisms, and/or other features of the user. In some examples, the user may desire that the avatar representing the person in the virtual environment appear as a digital twin of the user. In any virtual environment, it is important for an XR system to efficiently generate high-quality avatars (e.g., realistically representing the appearance, movement, etc. of the person) in a low-latency manner. It can also be important for the XR system to render audio in an effective manner to enhance the XR experience.

In some cases, an XR system can include an optical “see-through” or “pass-through” display (e.g., see-through or pass-through AR HMD or AR glasses), allowing the XR system to display XR content (e.g., AR content) directly onto a real-world view without displaying video content. For example, a user may view physical objects through a display (e.g., glasses or lenses), and the AR system can display AR content onto the display to provide the user with an enhanced visual perception of one or more real-world objects. In one example, a display of an optical see-through AR system can include a lens or glass in front of each eye (or a single lens or glass over both eyes). The see-through display can allow the user to see a real-world or physical object directly, and can display (e.g., projected or otherwise displayed) an enhanced image of that object or additional AR content to augment the user's visual perception of the real world.

As noted previously, a foveated image may have different resolutions in different regions within the image. For example, a foveated image may include a highest resolution in a region of interest (ROI) and one or more lower-resolution regions around the ROI (e.g., in one or more “peripheral regions”).

A foveated-image sensor can be configured to capture an image of an ROI of a field of view in high resolution. The image may be referred to as a “fovea region” or an “ROI.” The foveated-image sensor may also capture another image of the full field of view at a lower resolution. The portion of the lower-resolution image that is outside the ROI may be referred to as the peripheral region. The image of the ROI may be inset into the other image of the peripheral region. The combine image may be referred to as a foveated image. In some aspects, foveated-image capture may operate at multiple tiers of resolution, for example, with an ROI at a highest resolution, a first-tier peripheral region (e.g., outside the ROI) at a second-highest resolution, a second-tier peripheral region (e.g., outside the first-tier peripheral region) at a third-highest resolution, etc.

Additionally or alternatively, a processor can render or process a foveated image with image data of an ROI at a higher resolution and image data of a peripheral region at a lower resolution. For example, an image sensor may load image data into memory (the image data may be foveated image data or images data with all the pixels at the same resolution). When processing the image data, an image processor may retrieve the image data from the memory at different resolutions. For example, the image processor may retrieve pixels of an ROI at a first resolution and pixels of a peripheral region at a second resolution. The image processor may process the retrieved pixels. Additionally or alternatively, an image processor may perform different image processing techniques, or a different number of processing operations for different regions. For example, the image processor may process pixels of an ROI using a first number of image-processing operations and pixels of a peripheral region using a second number of image-processing operations.

Additionally or alternatively, a processor, a display driver, and/or a display may display foveated image with image data of an ROI displayed at a higher resolution and image data of a peripheral region displayed at a lower resolution. For example, a display driver may receive images data from an image processor. The display driver may cause a display to display pixels in an ROI to be displayed at a first resolution and pixels in a peripheral region to be displayed at a second resolution.

XR applications may benefit from foveated image capturing, rendering, processing, and/or displaying. For example, some XR head-mounted displays (HMDs) may render, process, and/or display foveated image data, (e.g., virtual content to be displayed at the HMD) in a foveated manner. The image data may be rendered, processed, and/or displayed at different qualities and/or resolutions at different regions of the image data. For example, the image data may be rendered at a highest resolution and/or quality in an ROI and at a lower resolution and/or quality outside the ROI.

As an example, some XR HMDs may implement video see through (VST). In VST, an XR HMD may capture images of a field of view of a user and display the images to the user as if the user were viewing the field of view directly. While displaying the images of the field of view, the XR HMD may alter or augment the images providing the user with an altered or augmented view of the environment of the user (e.g., providing the user with an XR experience). VST may benefit from foveated image capture, foveated image processing, foveated image rendering and/or foveated image display.

Foveated image capturing, rendering, processing, and/or displaying may be useful in XR because foveated-image sensing, rendering, processing, and/or displaying may allow an XR HMD to conserve computational resources (e.g., power, processing time, communication bandwidth etc.). For example, a foveated image of a field of view (or a smaller area) may be smaller in data size than a full-resolution image of the same field of view (or the same smaller area) because the peripheral region of the foveated image may have lower resolution and may be stored using less data. Thus, capturing, storing, processing, rendering, and/or displaying a foveated image rather than a full-resolution image may conserve computational resources.

Some devices may capture, process, render, and/or display foveated images based on a gaze of a user. For example, some devices (e.g., XR HMDs) may determine a gaze of a view (e.g., where the viewer is gazing within an image frame) and determine an ROI for foveated imaging based on the gaze. The device may then capture, render, process, and/or display image data (e.g., foveated image data) to have the highest resolution in the ROI and lower resolution outside the ROI (e.g., at “peripheral regions”).

It may take time for a foveated-imaging system to adjust an image sensor to capture foveated images. For example, a foveated-imaging system may capture images of eyes of a user, determine a gaze of the user based on the images, determine an ROI based on the gaze, and register the ROI with an image sensor. There may be a delay between when the ROI is determined and when the ROI is registered with the image sensor. The delay may take as much time as it takes for the image sensor to capture several frames of video data. During this delay, the user's gaze may change. If the user's gaze changes, by the time a foveated image is captured, processed, and displayed, the user may not be gazing at the ROI of the foveated image (or at least not at the center of the ROI).

Systems, apparatuses, methods (also referred to as processes), and computer-readable media (collectively referred to herein as “systems and techniques”) are described herein for processing image data. For example, the systems and techniques described herein may determine a first ROI based on gaze data and provide an indication of the first ROI to an image sensor. Additionally, the systems and techniques may determine a second ROI and provide an indication of the second ROI to an image processor. Registering an ROI with an image processor may be faster than registering an ROI with an image sensor. So, the systems and techniques may be able to cause an image processor to begin operating based on the second ROI sooner than the image sensor begins operating on the first ROI. The image processor may process image data based on the second ROI sooner than the image processor can process image data captured based on the first ROI.

The second ROI may be smaller than the first ROI. For example, the first ROI may be designed to be large to compensate for the delay in determining and registering an ROI with the image sensor. The second ROI may be smaller than the first ROI based on the comparative speed at which the second ROI can be registered with the image processor.

By causing the image processor to process image data based on the second ROI, the systems and techniques may conserve computational resources (e.g., processing time and/or power) by processing less data at a higher resolution (based on the second ROI being smaller than the first ROI) and more data at a lower resolution.

Various aspects of the application will be described with respect to the figures below. \

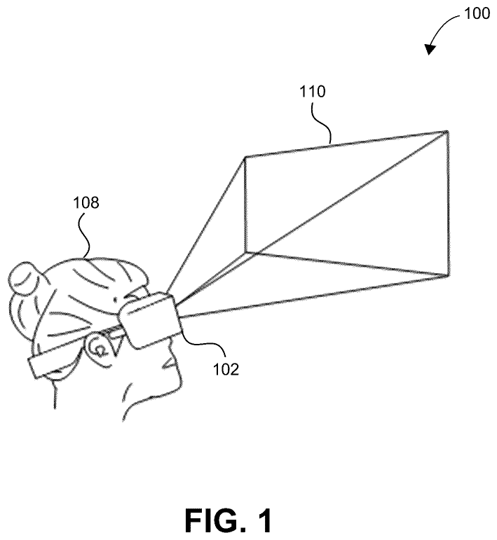

FIG. 1 is a diagram illustrating an example extended-reality (XR) system 100, according to aspects of the disclosure. As shown, XR system 100 includes an XR device 102. XR device 102 may implement, as examples, image-capture, object-detection, gaze-tracking, view-tracking, localization, computational, and/or display aspects of extended reality, including virtual reality (VR), augmented reality (AR), and/or mixed reality (MR). For example, XR device 102 may include one or more scene-facing cameras that may capture images of a scene in which user 108 uses XR device 102. XR device 102 may detect objects in the scene based on the images of the scene. Further, XR device 102 may include one or more user-facing cameras that may capture images of eyes of user 108. XR device 102 may determine a gaze of user 108 based on the images of user 108. XR device 102 may generate, determine, obtain, and/or render information (e.g., text, images, and/or video). XR device 102 may display the information to a user 108 (e.g., within a field of view 110 of user 108).

XR device 102 may display the information to be viewed by a user 108 in field of view 110 of user 108. For example, in a “see-through” configuration, XR device 102 may include a transparent surface (e.g., optical glass) such that information may be displayed on (e.g., by being projected onto) the transparent surface to overlay the information onto the scene as viewed through the transparent surface. In a “pass-through” configuration or a “video see-through” configuration, XR device 102 may include a scene-facing camera that may capture images of the scene of user 108. XR device 102 may display images or video of the scene, as captured by the scene-facing camera, and information overlaid on the images or video of the scene.

In various examples, XR device 102 may be, or may include, a head-mounted device (HMD), a virtual reality headset, and/or smart glasses. XR device 102 may include one or more cameras, including scene-facing cameras and/or user-facing cameras, a GPU, one or more sensors (e.g., such as one or more inertial measurement units (IMUs), image sensors, and/or microphones), and/or one or more output devices (e.g., such as speakers, display, and/or smart glass).

In some aspects, XR device 102 may be, or may include, two or more devices. For example, XR device 102 may include a display device and a processing device. The display device may generate data, such as image data (e.g., from user-facing cameras and/or scene-facing cameras) and/or motion data (from an inertial measurement unit (IMU)). The display device may provide the data to the processing device, for example, through a wireless connection. The processing device may process the data and/or other data. Further, the processing unit may generate data to be displayed at the display device. The processing device may provide the generated data to the display device, for example, through the wireless connection.

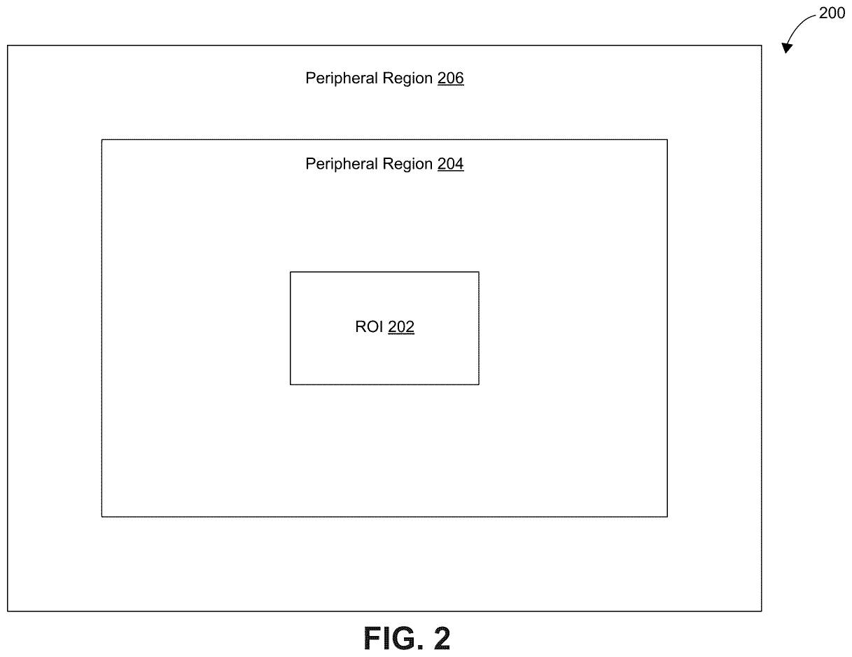

FIG. 2 includes a representation of an example foveated image, according to various aspects of the present disclosure. For example, image 200 is an example of an image frame including a ROI 202, a peripheral region 204, and a peripheral region 206. ROI 202 may have a first resolution. Peripheral region 204 may be around ROI 202 and may have a second resolution that is lower than the first resolution. Peripheral region 206 may be around peripheral region 204 and may have a third resolution lower than the second resolution. A foveated image, according to various aspects of the present disclosure, may have any number of ROIs and/or any number of peripheral regions. The ROIs may, or may not, be rectangular.

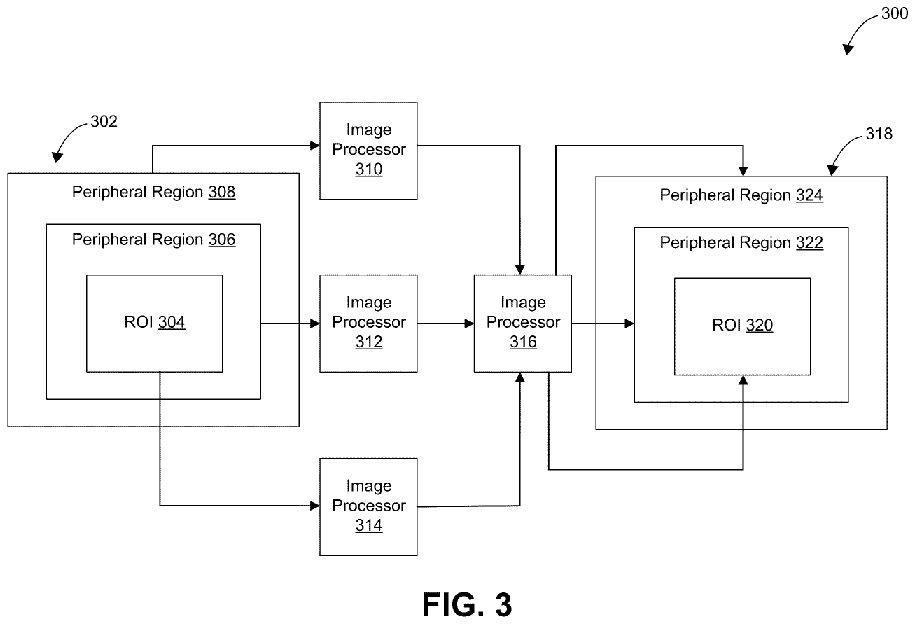

FIG. 3 is a block diagram illustrating an example system 300 for processing foveated image data, according to various aspects of the present disclosure. For example, system 300 may obtain foveated image data 302, which includes an ROI 304, a peripheral region 306, and a peripheral region 308. ROI 304 may include pixel data (e.g., red-green-blue (RGB) data or luma, blue projection, red projection (YUV) data) arranged in ROI 304 at a first resolution. Peripheral region 306 may include pixel data arranged in peripheral region 306 at a second resolution. Peripheral region 308 may include pixel data arranged in peripheral region 308 at a third resolution. The first resolution may be greater than the second resolution, which may be greater than the third resolution.

System 300 may obtain foveated image data 302 from a foveated-image sensor (e.g., an image sensor configured to generate foveated image data). The foveated image sensor may receive an indication of ROI 304 and capture foveated image data 302 with different resolutions at ROI 304, peripheral region 306, and peripheral region 308 based on the received indication of ROI 304. The foveated-image sensor may store foveated image data 302 in a memory (e.g., a random-access memory (RAM), such as a double-data-rate RAM (DDR RAM)) and system 300 may read foveated image data 302 from the memory.

System 300 may include an image processor 310, an image processor 312 and an image processor 312. Image processor 310 may process peripheral region 308, image processor 312 may process peripheral region 306, and image processor 314 may process ROI 304. Image processor 310, image processor 312, and image processor 314 may be regions of an image processor. For example, image processor 310, image processor 312, and image processor 314 may be respective regions of an image-processing engine (IPE). Alternatively, each of image processor 310, image processor 312, and image processor 314 may be a separate respective image processor (e.g., an IPE). Image processor 310, image processor 312, and image processor 314 may perform operations related to, for example, spatial/temporal noise processing, and/or tone mapping.

System 300 is illustrated with foveated image data 302 including one ROI and two peripheral regions and three corresponding image processors (image processor 310, image processor 312, and image processor 314) for illustrative purposes. In other cases, system 300 may include any number of image processors and foveated image data 302 may include any number of ROIs and/or peripheral regions.

System 300 may include an image processor 316 that may process processed outputs of image processor 310, image processor 312, and image processor 314. Image processor 316 may be, or may include, a graphics-processing unit (GPU). Image processor 316 may process the outputs of image processor 310, image processor 312, and image processor 314 to generate foveated image data 318. Image processor 316 may perform operations related to, for example, plane blending, alignment, and/or virtual-object rendering.

Foveated image data 318 may include a ROI 320, a peripheral region 322, and a peripheral region 324. ROI 320 may include pixel data arranged in ROI 320 at a first resolution. Peripheral region 322 may include pixel data arranged in peripheral region 322 at a second resolution. Peripheral region 324 may include pixel data arranged in peripheral region 324 at a third resolution. The first resolution may be greater than the second resolution, which may be greater than the third resolution.

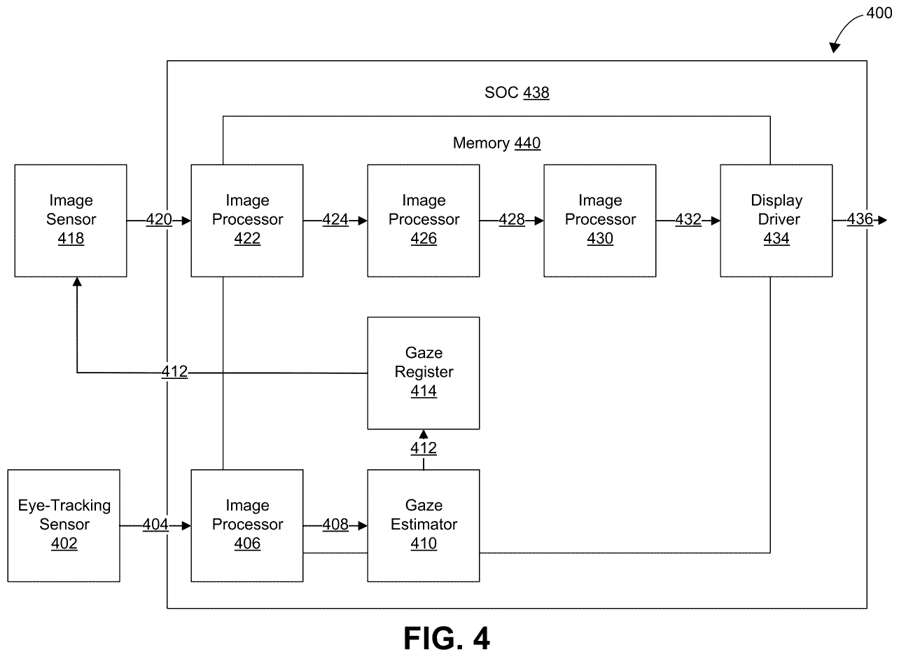

FIG. 4 is a block diagram illustrating an example system 400 for processing foveated image data, according to various aspects of the present disclosure. An eye-tracking sensor 402 may capture facial images 404. For example, eye-tracking sensor 402 may be, or may include, one or more cameras facing a user of a device (e.g., an HMD). Facial images 404 may include images of at least a portion of the face of a user, including one or both eyes of the user.

An image processor 406 may process facial images 404 to generate facial images 408. Image processor 406 may perform such tasks as noise processing on facial images 404.

A gaze estimator 410 may determine ROI 412 based on facial images 408. For example, gaze estimator 410 may determine a position within an image frame at which the user is looking. For example, gaze estimator 410 may translate a position of eyes of the user in facial images 404 into a position within an image frame of an image being displayed to the user.

In some aspects, gaze estimator 410 may predict a future gaze of the user. For example, in addition to determining where the user is currently looking, gaze estimator 410 may predict where the user will look at a future time based on facial images 408. In some aspects, gaze estimator 410 may determine or predict the gaze according to a series-prediction technique. In other aspects, gaze estimator 410 may determine or predict the gaze using a machine-learning model trained to predict a gaze. As such, ROI 412 may be based on a predicted gaze of the user. ROI 412 may represent an indication of an ROI (e.g., pixel coordinates of the ROI within an image frame).

Gaze register 414 may cause image sensor 418 to capture foveated image data based on ROI 412. For example, gaze register 414 may store an indication of ROI 412 in a register accessible by image sensor 418 such that image sensor 418 captures foveated image data 420 based on ROI 412.

Image sensor 418 may be, or may include, an image sensor configurable to capture foveated image data. For example, image sensor 418 may be configurable to capture image data with various resolutions in various respective regions (e.g., as described with regard to image 200 of FIG. 2).

Image sensor 418 may capture foveated image data 420 based on ROI 412. For example, image sensor 418 may capture foveated image data 420 such that foveated image data 420 has a highest resolution in ROI 412 and one or more lower resolutions in one or more peripheral regions. foveated image data 420 may be an example of foveated image data 302 of FIG. 3.

Image processor 422 may process eye-tracking sensor 402 to generate foveated image data 424. Image processor 422 may perform tasks, such as noise reduction on foveated image data 420. Image processor 422 may perform operations related to, for example, Bayer processing, statistics collection, noise processing, and/or pixel corrections.

Image processor 422 may be, or may include, an image front-end (IFE) image processor. For example, image processor 422 may obtain foveated image data 420 directly from image sensor 418. After processing foveated image data 420, image processor 422 may store foveated image data 424 in a memory 440 (e.g., a RAM, such as a DDR RAM). Image processor 426 may obtain (e.g., receive, fetch or retrieve, etc.) foveated image data 424 from memory 440. In contrast, image processor 422 may obtain foveated image data 420 at an interface (e.g., a bus or other interface) between image sensor 418 and image processor 422.

Image processor 426 may be an example of image processor 310, image processor 312, and image processor 314 of FIG. 3. Image processor 426 may be an image-processing engine (IPE). Image processor 426 may process foveated image data 424 to generate foveated image data 428. Image processor 426 may store foveated image data 428 in memory 440. Image processor 426 may perform operations related to, for example, spatial/temporal noise processing, and/or tone mapping.

Image processor 430 may be an example of image processor 316 of FIG. 3. Image processor 430 may be a graphics processing unit (GPU). Image processor 430 may read foveated image data 428 from memory 440, process foveated image data 428 to generate foveated image data 432, and store foveated image data 432 in memory 440. Image processor 430 may perform operations related to, for example, plane blending, alignment, and/or virtual-object rendering.

Display driver 434 may read foveated image data 432 from memory 440 and condition foveated image data 432 to generate foveated image data 436 and provide foveated image data 436 to a display such that the display displays foveated image data 436.

Image processor 406, gaze estimator 410, gaze register 414, image processor 422, image processor 426, image processor 430, and/or display driver 434 may be implemented on a system-on-a-chip (SOC) 438. SOC 438 may enable relatively quick communications between image processor 406, gaze estimator 410, gaze register 414, image processor 422, image processor 426, image processor 430, and/or display driver 434. For example, SOC 438 may enable image processor 406, gaze estimator 410, gaze register 414, image processor 422, image processor 426, image processor 430, and/or display driver 434 to write data to, and read data from, memory 440 relatively quickly. For example, communications between gaze register 414 and image processor 422 may be faster than communications between gaze register 414 and image sensor 418.

There may be latency (e.g., a delay) in gaze register 414 registering ROI 412 with image sensor 418. For example, if image sensor 418 capturing foveated image data 420 repeatedly, for example, at a rate, such as 30 frames per second (fps), there may be a delay that equates to the time to capture several frames between when ROI 412 is determined and when image sensor 418 is able to capture frames according to ROI 412. Accordingly, if a gaze of a user changes over time, foveation at image sensor 418 may lag behind the user's gaze based on the latency of registering ROI 412 with image sensor 418.

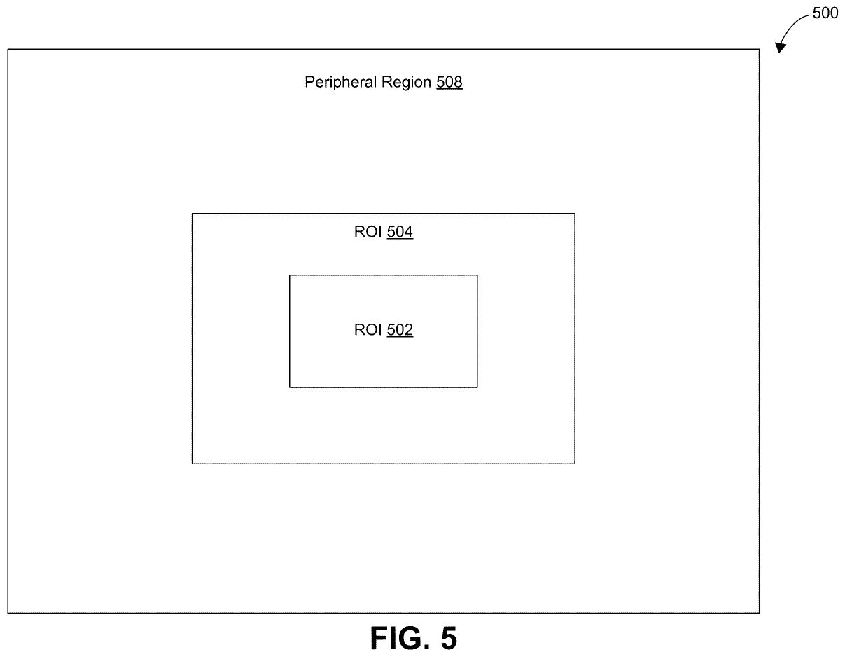

To account for such a delay, one solution is to generate an ROI of an image that is larger than what would otherwise be needed. For example, FIG. 5 includes an illustration of an example foveated image 500 including an ROI 502, an ROI 504, a peripheral region 506, and a peripheral region 508, according to various aspects of the present disclosure. A user may be able to focus on an area the size of ROI 502. Accordingly, it may be important, for foveated imaging, to render ROI 502 with a high resolution. However, because a user's gaze may change between when ROI 502 is determined and when image sensor 418 can capture foveated image 500 with a high resolution at ROI 502 and a lower resolution at peripheral region 506, system 400 may cause image sensor 418 to capture ROI 504 (which is bigger than ROI 502) at a high resolution.

Capturing ROI 504 at a high resolution may improve a user's experience with foveated imaging because even if the user's gaze moves, the user's gaze will be within the ROI 504 and the user will see high resolution image data where the user can focus their eyes. However, capturing and processing ROI 504 at a high resolution, rather than capturing and processing ROI 502 at the high resolution may conserve more computational resources than capturing and processing ROI 502 at a high resolution and capturing and processing ROI 504 at a lower resolution. In other words, expanding the size of an ROI to account for a delay in registering the ROI with the image sensor may decrease some of the computational-resource conservation of foveated imaging.

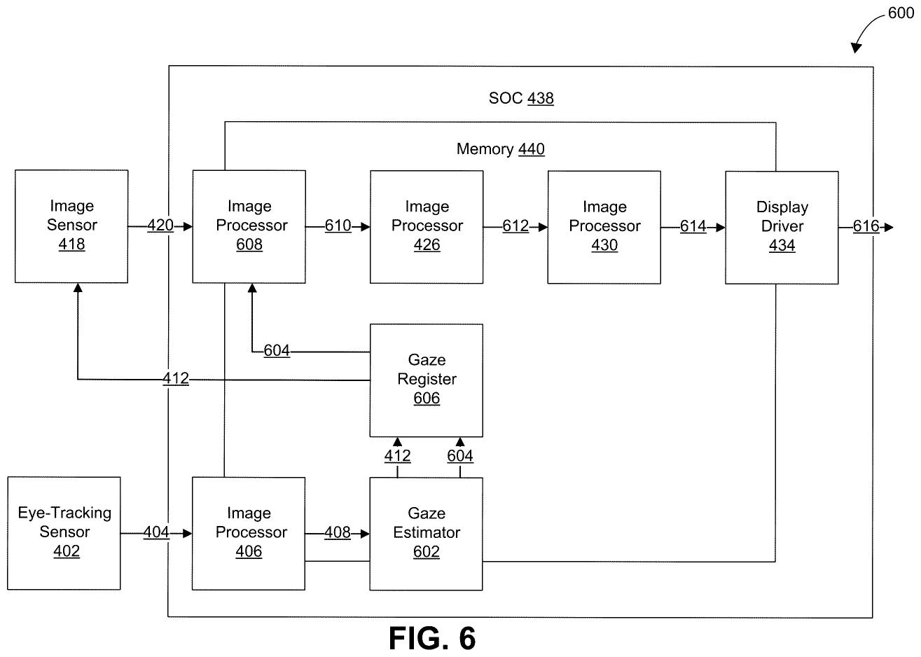

FIG. 6 is a block diagram illustrating an example system 600 for processing foveated image data, according to various aspects of the present disclosure. System 600 includes system 400 with modifications. For example, gaze estimator 602 may be substantially similar to gaze estimator 410 of FIG. 4, however, in addition to generating ROI 412, gaze estimator 602 may generate ROI 604. Gaze register 606 may be substantially similar to gaze register 414, however, in addition to registering ROI 412 with image sensor 418, gaze register 606 may provide ROI 604 to image processor 608. Similarly, image processor 608 may be substantially similar to image processor 422, however, image processor 608 may generate foveated image data 610 based on foveated image data 420 and ROI 604.

System 600 may conserve conservational resources as compared with system 400 by providing image processor 608 with an indication of ROI 604 such that image processor 608 may process foveated image data 420 based on ROI 604 and further so that image processor 426, image processor 430, and/or display driver 434 may respectively process foveated image data 610, foveated image data 612, and foveated image data 614 based on ROI 604.

Gaze estimator 602 may predict ROI 412 several frames in the future based on the delay of registering ROI 412 with image sensor 418. Additionally, gaze estimator 410 may oversize ROI 412 based on the uncertainty inherent in predicting ROI 412 based on the delay (e.g., as illustrated and described with regard to ROI 504 of FIG. 5). In this, gaze estimator 602 may behave the same as gaze estimator 410.

Additionally, gaze estimator 602 may generate ROI 604. In some aspects, gaze estimator 602 may generate ROI 604 based on a current gaze of the user, without predicting the gaze. In some aspects, gaze estimator 602 may predict ROI 412 based on ROI 604. For example, gaze estimator 602 may determine ROI 604 based on a current gaze of the user and predict ROI 412 based on ROI 604.

In other aspects, gaze estimator 602 may predict ROI 604 in the future, but less distant in the future than gaze estimator 602 predicts ROI 412 based on the relative speed at which gaze register 606 can provide ROI 604 to image processor 608 (as compared with the speed at which gaze register 606 provides ROI 412 to image sensor 418). For example, in cases in which image sensor 418 captures foveated image data 420 at a rate, for example, 30 fps, gaze estimator 602 may predict ROI 412 three frames in the future (e.g., based on a delay that equates to the time it takes for image sensor 418 to capture three frames between when gaze estimator 602 determines ROI 412 and when image sensor 418 may capture a frame of foveated image data 420 based on ROI 412). Additionally, gaze estimator 602 may predict ROI 604 one frames in the future (e.g., based on the time it takes for gaze register 606 to provide ROI 604 to image processor 608).

Eye-tracking sensor 402 may capture facial images 404 at repeated intervals. Gaze estimator 602 may determine ROI 412 and/or ROI 604 for each instance of facial images 408 received. For example, eye-tracking sensor 402 may capture facial images 404 at a rate of 30 fps and gaze estimator 602 may determine 30 instances of ROI 412 and 30 instances of ROI 604 every second based on the facial images 404. As such, gaze estimator 602 may dynamically determine ROI 412 and ROI 604 based on the eyes of the user.

Image processor 608 may process foveated image data 420 based on ROI 604. For example, image sensor 418 may capture foveated image data 420 based on ROI 412. Image sensor 418 may provide foveated image data 420 to image processor 422. Foveated image data 420 may have an ROI based on ROI 412 (e.g., an ROI sized like ROI 504 of FIG. 5). However, image processor 608 may process foveated image data 420 as if the ROI were sized based on ROI 604 (e.g., sized like ROI 502 of FIG. 5).

To process foveated image data 420 based on ROI 604, image processor 608 may crop the ROI of foveated image data 420. For example, when obtaining foveated image data 420, image processor 608 may obtain image data sized based on ROI 412 (e.g., similar to what is illustrated with regard to image processor 314 receiving ROI 304 of FIG. 3). Additionally, image processor 608 may obtain image data sized based on one or more peripheral regions (e.g., similar to what is illustrated with regard to image processor 312 of FIG. 3 receiving peripheral region 306 and image processor 310 of FIG. 3 receiving peripheral region 308). The image data of the one or more peripheral regions may include an entire frame's worth of image data at the one or more lower resolutions. Thus cropping the image data sized based on ROI 412 may removing high-resolution image data from the image data based on ROI 412. Yet, the portion cropped from the image data sized based on ROI 412 may be included in the imaged data based on the one or more peripheral regions.

Gaze estimator 602 may generate ROI 604 to be smaller than ROI 412 because gaze estimator 602 may generate ROI 604 based on a current gaze, without predicting the future gaze. Alternatively, gaze estimator 602 may generate ROI 604 to be smaller than ROI 412 because gaze estimator 602 predicts ROI 604 for a time less distant in the future than the time for which gaze estimator 602 predicts ROI 412. For example, when gaze estimator 602 predicts ROI 412 three frames in the future, gaze estimator 602 may size ROI 412 to be relatively large (e.g., as illustrated by ROI 504 of FIG. 5) based on the uncertainty in predicting a gaze three frames in the future. In contrast, when gaze estimator 602 determines ROI 604 based on a current gaze, or predicts ROI 604 one frame in the future, gaze estimator 602 may be more certain of the gaze or prediction and may accordingly size ROI 604 to be smaller than ROI 412 (e.g., as illustrated by ROI 502 of FIG. 5).

Image processor 608 may obtain foveated image data 420 with an ROI sized based on ROI 412. Image processor 422 may generate foveated image data 610 such that foveated image data 610 has an ROI sized based on ROI 604. Thus, foveated image data 610 may be smaller than foveated image data 420. Thus, image processor 426 may consume less computational resources when processing foveated image data 610 (e.g., according to system 600) than when processing foveated image data 424 (e.g., according to system 400). Similarly, image processor 430 may consume less computational resources when processing foveated image data 612 (e.g., according to system 600) than when processing foveated image data 428 (e.g., according to system 400). Further, display driver 434 may consume less computational resources when processing foveated image data 614 (e.g., according to system 600) than when processing foveated image data 432 (e.g., according to system 400).

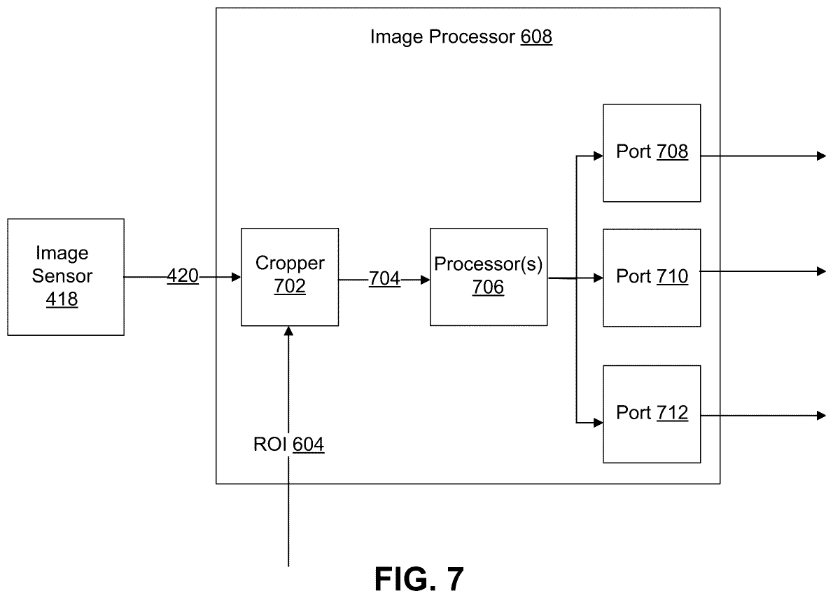

FIG. 7 is a block diagram illustrating an example implementation of image processor 608 of FIG. 6, according to various aspects of the present disclosure. In general, image processor 608 may process foveated image data 420 based on ROI 604.

Image processor 608 includes cropper 702 which may crop foveated image data 420 based on ROI 604. For example, cropper 702 may crop ROI image data according to ROI 604. For example, foveated image data 420 may include image data sized based on an ROI (e.g., ROI 304 of FIG. 3) and image data sized based on one or more peripheral regions (e.g., peripheral region 306 and peripheral region 308). Cropper 702 may crop the image data sized based on the ROI. For example, cropper 702 may fetch only a portion of ROI 304 from memory. Cropper 702 may provide foveated image data 704 to processor(s) 706.

Processor(s) 706 may be, or may include, one or more processors performing one or more tasks. For example, processor(s) 706 may process foveated image data 704 and provide processed image data to one or more ports (e.g., port 708, port 710, and port 712). Processor(s) 706 may, for example, perform noise reduction, color processing, Bayer processing and/or other image-processing techniques on foveated image data 704.

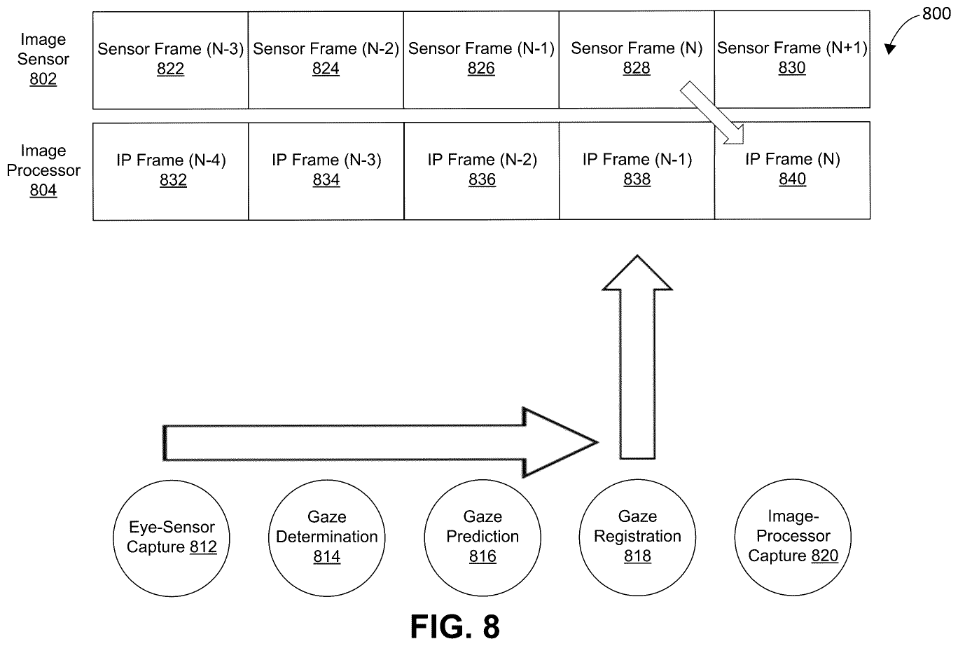

FIG. 8 is a timing diagram illustrating an example process 800 for processing foveated image data. Process 800 may describe the processing of foveated image data by system 400 of FIG. 4. Image sensor 802 may be an example of image sensor 418 of FIG. 4 and image processor 804 may be an example of image processor 422 of FIG. 4.

In general, at event 812, a user-facing camera (e.g., eye-tracking sensor 402) may capture an image of a face of a user. At event 814, a gaze estimator (e.g., gaze estimator 410) may determine a current gaze of the user based on the image of the face of the user. At event 816, a gaze predictor (e.g., gaze estimator 410) may predict a gaze of the user for a future time. At event 818, an ROI (e.g., ROI 412) may be registered at an image sensor 802 (e.g., image sensor 418). For example, gaze register 414 may register ROI 412 with image sensor 418. At event 820, image sensor 802 may capture an image (e.g., foveated image data 420) based on the ROI and provide the image to an image processor 804 (e.g., image processor 422).

At or about the time of event 812, image sensor 802 may capture a sensor frame (N−3) 822 and image processor 804 may process an IP frame (N-4) 832. At or about the time of event 814, image sensor 802 may capture a sensor frame (N−2) 824 and image processor 804 may process an IP frame (N−3) 834, which may be the image captured by image sensor 802 at or about the time of event 812. For example, image sensor 802 may provide sensor frame (N−3) 822 to image processor 804 and image processor 804 may process sensor frame (N−3) 822 as IP frame (N-4) 832. At or about the time of event 816, image sensor 802 may capture a sensor frame (N−1) 826 and image processor 804 may process an IP frame (N−2) 836, which may be the image captured by image sensor 802 at or about the time of event 814. For example, image sensor 802 may provide sensor frame (N−2) 824 to image processor 804 and image processor 804 may process sensor frame (N−2) 824 as IP frame (N−3) 834. At or about the time of event 818, image sensor 802 may capture a sensor frame (N) 828 and image processor 804 may process an IP frame (N−1) 838, which may be the image captured by image sensor 802 at or about the time of event 816. For example, image sensor 802 may provide sensor frame (N−1) 826 to image processor 804 and image processor 804 may process sensor frame (N−1) 826 as IP frame (N−2) 836. At or about the time of event 820, image sensor 802 may capture a sensor frame (N+1) 830 and image processor 804 may process an IP frame (N) 840, which may be the image captured by image sensor 802 at or about the time of event 818. For example, image sensor 802 may provide sensor frame (N) 828 to image processor 804 and image processor 804 may process sensor frame (N) 828 as IP frame (N−1) 838.

According to process 800, there may be a three-frame delay between the time a user-facing camera captures an image of eyes of a user to the time image sensor 802 captures a foveated image based on the based on an ROI determined based on the image of the eyes of the user. By the time sensor frame (N) 828 is captured, it is captured based on an ROI that was determined a time equating to the capture of three frames prior.

Additionally, by the time IP frame (N) 840 is processed, a time equating to the capture of four frames has passed. The ROI on which sensor frame (N) 928 was captured is based on an image of the eyes that is four frames old. For example, frames sensor frame (N−3) 822, sensor frame (N−2) 824, sensor frame (N−1) 826, and sensor frame (N) 828 are captured in the time between event 812 and event 820.

FIG. 8 illustrates event 812, event 814, event 816, event 818, and event 820 that may occur relative to the processing of sensor frame (N) 828 and IP frame (N) 840 (e.g., sensor frame (N) 828 as received by image processor 804). Although not illustrated in FIG. 8, the operations associated with event 812, event 814, event 816, event 818, and event 820 may be repeated for each of sensor frame (N−3) 822, sensor frame (N−2) 824, and sensor frame (N+1) 830. According to process 800, image data processed at image processor 804 may continually be four frames delayed.

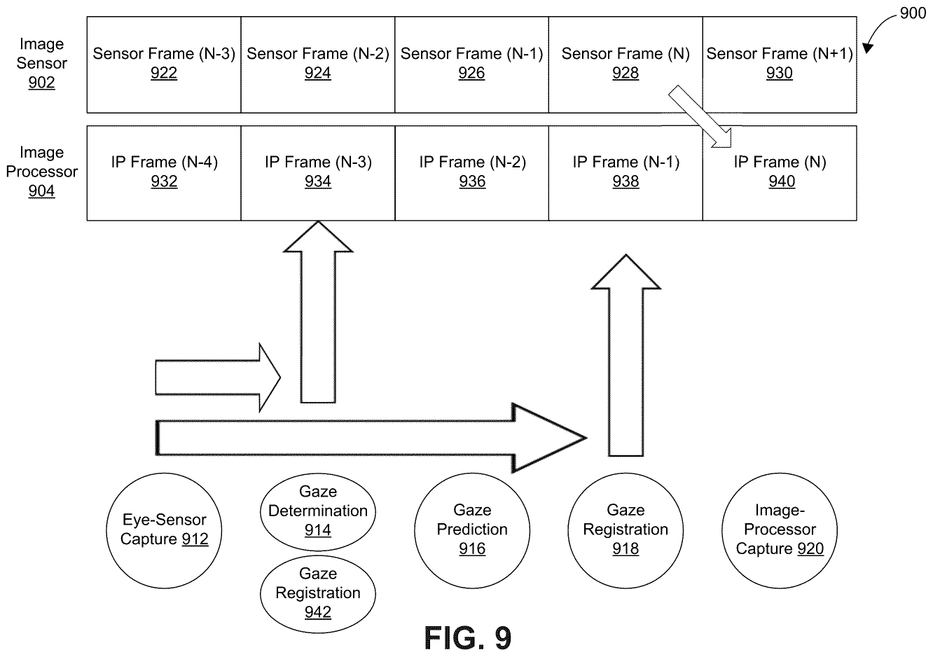

FIG. 9 is a timing diagram illustrating an example process 900 for processing foveated image data, according to various aspects of the present disclosure. Process 900 may describe the processing of foveated image data by system 600 of FIG. 6. Image sensor 902 may be an example of image sensor 418 of FIG. 6 and image processor 904 may be an example of image processor 608 of FIG. 6.

In general, at event 912, a user-facing camera (e.g., eye-tracking sensor 402) may capture an image of a face of a user. At event 914, a gaze estimator (e.g., gaze estimator 602) may determine a current gaze of the user based on the image of the face of the user. At event 916, a gaze predictor (e.g., gaze estimator 602) may predict a gaze of the user for a future time. At event 918, an ROI (e.g., ROI 412) may be registered at an image sensor 902 (e.g., image sensor 418). For example, gaze register 606 may register ROI 412 with image sensor 418. At event 920, image sensor 902 may capture an image (e.g., foveated image data 420) based on the ROI and provide the image to an image processor 904 (e.g., image processor 608).

At event 942, which may occur after (e.g., immediately after) event 914, an ROI may be registered with image processor 904. For example, gaze estimator 602 may provide ROI 604 to image processor 608. When image processor 904 receives the ROI, image processor 904 may process IP frame (N−3) 934 based on the received ROI. For example, as described with regard to FIG. 7 and FIG. 6, image processor 904 may crop IP frame (N−3) 934 based on the received ROI.

Sensor frame (N−3) 922 may be the same as, or may be substantially similar to, sensor frame (N−3) 822, sensor frame (N−2) 924 may be the same as, or may be substantially similar to, sensor frame (N−2) 824, sensor frame (N−1) 926 may be the same as, or may be substantially similar to, sensor frame (N−1) 826, sensor frame (N) 928 may be the same as, or may be substantially similar to, sensor frame (N) 828, sensor frame (N+1) 930 may be the same as, or may be substantially similar to, sensor frame (N+1) 830, IP frame (N−4) 932 may be the same as, or may be substantially similar to, IP frame (N−4) 832, IP frame (N−3) 934 may be the same as, or may be substantially similar to, IP frame (N−3) 834, IP frame (N−2) 936 may be the same as, or may be substantially similar to, IP frame (N−2) 836, IP frame (N−1) 938 may be the same as, or may be substantially similar to, IP frame (N−1) 838, IP frame (N) 940 may be the same as, or may be substantially similar to, IP frame (N) 840.

Similar to process 800, according to process 900, there may be a three-frame delay between the time a user-facing camera captures an image of eyes of a user to the time image sensor 902 captures a foveated image based on the based on an ROI determined based on the image of the eyes of the user. By the time sensor frame (N) 928 is captured, it is captured based on an ROI that was determined a time equating to the capture of three frames prior.

In contrast to process 800, process 900 may cause image processor 904 to process frames based on newer ROI data. For example, image processor 904 may process IP frame (N−3) 934 based on a gaze determined at event 942 and registered with image processor 904 at event 942. Thus, image processor 904 may process IP frame (N−3) 934 with an ROI that is only one frame old. Similarly, though not illustrated in FIG. 9, at or about the time of event 918, eye-tracking sensor 402 may capture another image of the eyes of the user and at or about the time of event 920, image processor 608 may determine ROI 604 and provide ROI 604 to image processor 904. Thus, at or about the time of event 920, image processor 904 may receive an ROI based on an image of the eyes of the user capture at or about the time of event 918 and image processor 904 may process IP frame (N) 940 based on the newer ROI. According to process 900, image data processed at image processor 904 may continually one frame delayed.

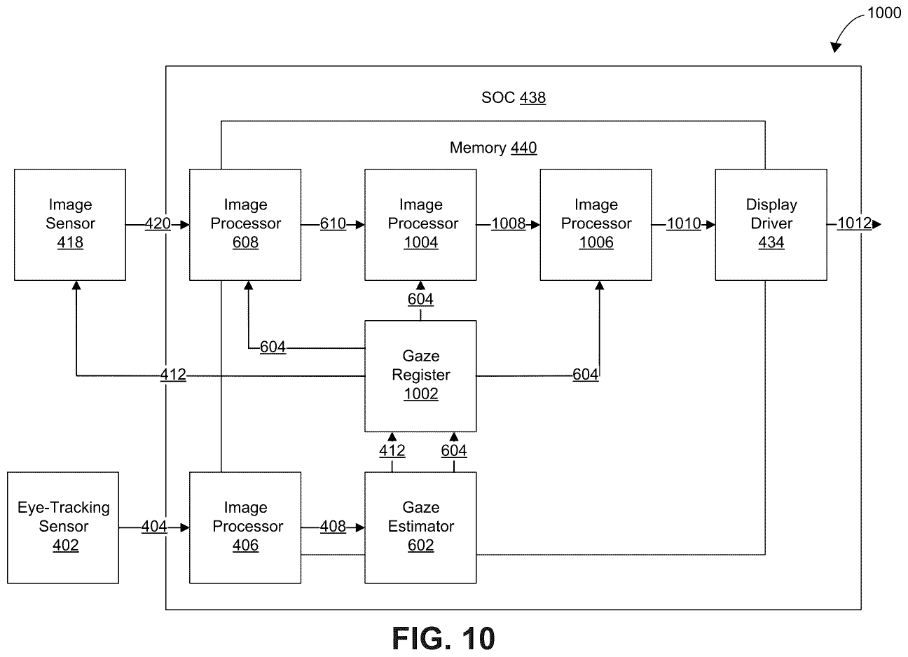

FIG. 10 is a block diagram illustrating an example system 1000 for processing foveated image data, according to various aspects of the present disclosure. System 1000 includes system 600 with modifications. For example, gaze estimator 602 may generate ROI 412 and ROI 604. Gaze register 1002 may be substantially similar to gaze register 606, however, in addition to providing ROI 412 to image sensor 418, and providing ROI 604 to image processor 608, gaze register 1002 may provide ROI 604 to image processor 1004 and/or image processor 1006. Image processor 1004 may be substantially similar to image processor 426, however image processor 1004 may generate foveated image data 1008 based on foveated image data 610 and ROI 604. For example, image processor 1004 may crop foveated image data 610 based on ROI 604 before processing foveated image data 610. Similarly, image processor 1006 may be substantially similar to image processor 430, however image processor 1004 may generate foveated image data 1010 based on foveated image data 1008 and ROI 604. For example, image processor 1006 may crop foveated image data 1008 based on ROI 604 before processing foveated image data 610.

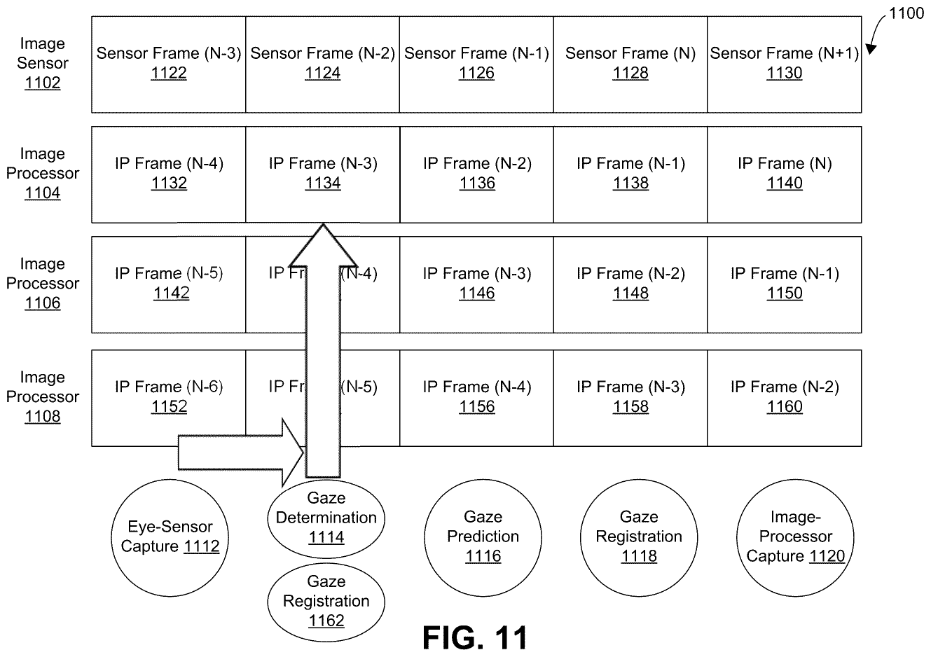

FIG. 11 is a timing diagram illustrating an example process 1100 for processing foveated image data, according to various aspects of the present disclosure. Process 1100 may describe the processing of foveated image data by system 1000 of FIG. 10. Image sensor 1102 may be an example of image sensor 418 of FIG. 10, image processor 1104 may be an example of image processor 608 of FIG. 10, image processor 1106 may be an example of image processor 1004 of FIG. 10, and image processor 1108 may be an example of image processor 1006 of FIG. 10.

In general, at event 1112, a user-facing camera (e.g., eye-tracking sensor 402) may capture an image of a face of a user. At event 1114, a gaze estimator (e.g., gaze estimator 602) may determine a current gaze of the user based on the image of the face of the user. At event 1116, a gaze predictor (e.g., gaze estimator 602) may predict a gaze of the user for a future time. At event 1118, an ROI (e.g., ROI 412) may be registered at an image sensor 1102 (e.g., image sensor 418). For example, gaze register 1002 may register ROI 412 with image sensor 418. At event 1120, image sensor 1102 may capture an image (e.g., foveated image data 420) based on the ROI and provide the image to an image processor 1104 (e.g., image processor 608).

At event 1162, which may occur after (e.g., immediately after) event 1114, an ROI may be registered with image processor 1104, image processor 1106, and image processor 1108. For example, gaze register 1002 may provide ROI 604 to image processor 608, image processor 1004, and image processor 1006.

Sensor frame (N−3) 1122 may be the same as, or may be substantially similar to, sensor frame (N−3) 822, sensor frame (N−2) 1124 may be the same as, or may be substantially similar to, sensor frame (N−2) 824, sensor frame (N−1) 1126 may be the same as, or may be substantially similar to, sensor frame (N−1) 826, sensor frame (N) 1128 may be the same as, or may be substantially similar to, sensor frame (N) 828, sensor frame (N+1) 1130 may be the same as, or may be substantially similar to, sensor frame (N+1) 830, IP frame (N−4) 1132 may be the same as, or may be substantially similar to, IP frame (N−4) 832, IP frame (N−3) 1134 may be the same as, or may be substantially similar to, IP frame (N−3) 834, IP frame (N−2) 1136 may be the same as, or may be substantially similar to, IP frame (N−2) 836, IP frame (N−1) 1138 may be the same as, or may be substantially similar to, IP frame (N−1) 838, IP frame (N) 1140 may be the same as, or may be substantially similar to, IP frame (N) 840.

At or about the time of event 1112, image processor 1106 process an IP frame (N−5) 1142 and image processor 1108 may process an IP frame (N−6) 1152. At or about the time of event 1114, image processor 1106 may process an IP frame (N−4) 1144, which may be the image processed by image processor 1104 at or about the time of event 1112. For example, image processor 1104 may provide IP frame (N−4) 1132 to image processor 1106 and image processor 1106 may process IP frame (N−4) 1132 as IP frame (N−4) 1144. Additionally, at or about the time of event 1114, image processor 1108 may process an IP frame (N−5) 1154, which may be the image processed by image processor 1106 at or about the time of event 1112. For example, image processor 1106 may provide IP frame (N−5) 1142 to image processor 1108 and image processor 1108 may process IP frame (N−5) 1142 as IP frame (N−5) 1154. At or about the time of event 1116, image processor 1106 may process an IP frame (N−3) 1146, which may be the image processed by image processor 1104 at or about the time of event 1114. For example, image processor 1104 may provide IP frame (N−3) 1134 to image processor 1106 and image processor 1106 may process IP frame (N−3) 1134 as IP frame (N−3) 1146. Additionally, at or about the time of event 1116, image processor 1108 may process an IP frame (N−4) 1156, which may be the image processed by image processor 1106 at or about the time of event 1114. For example, image processor 1106 may provide IP frame (N−4) 1144 to image processor 1108 and image processor 1108 may process IP frame (N−4) 1144 as IP frame (N−4) 1156. At or about the time of event 1118, image processor 1106 may process an IP frame (N−2) 1148, which may be the image processed by image processor 1104 at or about the time of event 1116. For example, image processor 1104 may provide IP frame (N−2) 1136 to image processor 1106 and image processor 1106 may process IP frame (N−2) 1136 as IP frame (N−2) 1148. Additionally, at or about the time of event 1118, image processor 1108 may process an IP frame (N−3) 1158, which may be the image processed by image processor 1106 at or about the time of event 1116. For example, image processor 1106 may provide IP frame (N−3) 1146 to image processor 1108 and image processor 1108 may process IP frame (N−3) 1146 as IP frame (N−3) 1158. At or about the time of event 1120, image processor 1106 may process an IP frame (N−1) 1150, which may be the image processed by image processor 1104 at or about the time of event 1118. For example, image processor 1104 may provide IP frame (N−1) 1138 to image processor 1106 and image processor 1106 may process IP frame (N−1) 1138 as IP frame (N−1) 1150. Additionally, at or about the time of event 1120, image processor 1108 may process an IP frame (N−2) 1160, which may be the image processed by image processor 1106 at or about the time of event 1118. For example, image processor 1106 may provide IP frame (N−2) 1148 to image processor 1108 and image processor 1108 may process IP frame (N−2) 1148 as IP frame (N−2) 1160.

When image processor 1104 receives the ROI, image processor 1104 may process IP frame (N−3) 1134 based on the received ROI. For example, as described with regard to FIG. 7 and FIG. 6, image processor 1104 may crop IP frame (N−3) 1134 based on the received ROI.

Similarly, when image processor 1106 receives the ROI, image processor 1106 may process IP frame (N−4) 1144 based on the received ROI. For example, as described with regard to FIG. 7 and FIG. 6, image processor 1106 may crop IP frame (N−4) 1144 based on the received ROI.

Additionally, when image processor 1108 receives the ROI, image processor 1108 may process IP frame (N−5) 1154 based on the received ROI. For example, as described with regard to FIG. 7 and FIG. 6, image processor 1108 may crop IP frame (N−5) 1154 based on the received ROI.

At any given time each of image processor 1104, image processor 1106, and image processor 1108 may be processing different older frames. For example, at the time of event 1114, image processor 1104 is processing IP frame (N−3) 1134, image processor 1106 is processing IP frame (N−4) 1144, and image processor 1108 is processing IP frame (N−5) 1154. These frames can be cropped smaller and smaller as process 1100 progresses deeper into the processing pipeline (e.g., of FIG. 10) using a most recently determined ROI.

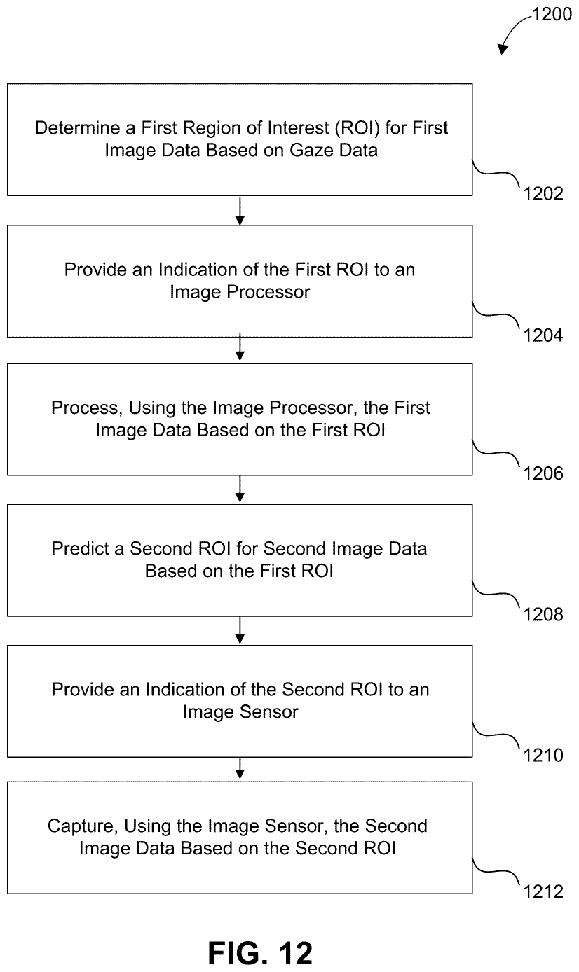

FIG. 12 is a flow diagram illustrating an example process 1200 for processing image data, in accordance with aspects of the present disclosure. One or more operations of process 1200 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1200. The one or more operations of process 1200 may be implemented as software components that are executed and run on one or more processors.

At block 1202, a computing device (or one or more components thereof) may determine a first region of interest (ROI) for first image data based on gaze data. For example, gaze estimator 602 may determine ROI 604 based on facial images 408.

At block 1204, the computing device (or one or more components thereof) may provide an indication of the first ROI to an image processor. For example, image processor 608 may provide ROI 604 to image processor 608.

At block 1206, the computing device (or one or more components thereof) may process, using the image processor, the first image data based on the first ROI. For example, image processor 608 may process foveated image data 420 based on ROI 604.

In some aspects, to process the first image data based on the first ROI, the computing device (or one or more components thereof) may fetch the first image data from memory based on the first ROI. For example, image processor 608 may fetch a foveated image data 420 from memory based on ROI 604.

In some aspects, to fetch the first image data from the memory based on the first ROI, computing device (or one or more components thereof) may fetch a subset of ROI image data available in the memory. For example, image processor 608 may fetch a subset of ROI 502 from memory. For example, image processor 314 may fetch a subset of ROI 304 from memory.

In some aspects, to process the first image data based on the first ROI, the computing device (or one or more components thereof) may process ROI image data within the first ROI at a higher resolution than non-ROI image data outside the first ROI. For example, image processor 608 may process image data within ROI 502 at a higher resolution than image processor 608 processes data outside ROI 502.

At block 1208, the computing device (or one or more components thereof) may predict a second ROI for second image data based on the gaze data. For example, gaze estimator 602 may predict ROI 412 based on facial images 408.

At block 1210, the computing device (or one or more components thereof) may provide an indication of the second ROI to an image sensor. For example, gaze register 606 may provide ROI 412 to image sensor 418.

At block 1212, the computing device (or one or more components thereof) may capture, using the image sensor, the second image data based on the second ROI. For example, image sensor 418 may capture foveated image data 420 based on ROI 412.

In some aspects, the first image data is captured by the image sensor and provided to the image processor prior to the second image data being captured by the image sensor. For example, image sensor 418 may capture foveated a first instance of image data 420 and provide the first instance of foveated image data 420 to image processor 608. Image processor 608 may process the first instance of foveated image data 420 at block 1206. Later, image sensor 418 may capture foveated a second instance of image data 420 at block 1212.

In some aspects, the first ROI is smaller than the second ROI. For example, the ROI indicated by ROI 604 (e.g., determined at block 1202) may be smaller than the ROI indicated by ROI 412 (e.g., determined at block 1208).

In some aspects, the image processor may be, or may include, a first image processor. The computing device (or one or more components thereof) may provide the indication of the first ROI to a second image processor; and process, using the second image processor, third image data based on the first ROI. For example, gaze register 1002 may provide ROI 604 to image processor 608, image processor 1004, and/or image processor 1006. Image processor 1004 may process foveated image data 610 based on ROI 604. Additionally or alternatively, image processor 1006 may process foveated image data 1008 based on ROI 604.

In some aspects, the gaze data may be, or may include, first gaze data. The computing device (or one or more components thereof) may: determine a third ROI for third image data based on second gaze data; provide an indication of the third ROI to the image processor; process, using the image processor, the third image data based on the third ROI; predict a fourth ROI for fourth image data based on the second gaze data; provide an indication of the fourth ROI to the image sensor; and capture, using the image sensor, the fourth image data based on the fourth ROI. For example, eye-tracking sensor 402 may provide a second instance of facial images 404 to image processor 406 and image processor 406 may provide a second instance of facial images 408 to gaze estimator 602. Gaze estimator 602 may generate a second instance of ROI 604. Gaze register 606 may provide the second instance of ROI 604 to image processor 608 and image processor 608 may process a third instance of foveated image data 420 based on the second instance of ROI 604. Additionally, gaze estimator 602 may determine a second instance of ROI 412 and provide the second instance of ROI 412 to image sensor 418. Image sensor 418 may capture a fourth instance of foveated image data 420 based on the second instance of ROI 412.

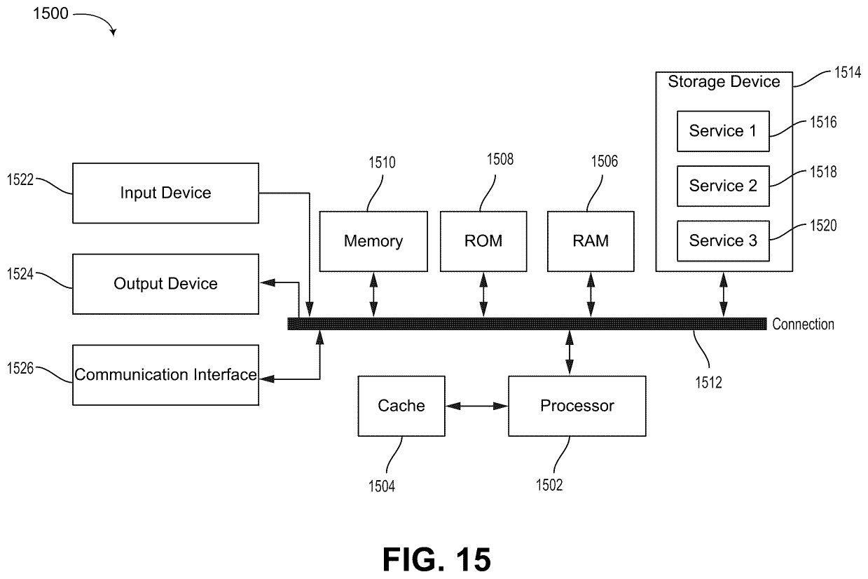

In some examples, as noted previously, the methods described herein (e.g., process 900 of FIG. 9, process 1100 of FIG. 11, process 1200 of FIG. 12, and/or other methods described herein) can be performed, in whole or in part, by a computing device or apparatus. In one example, one or more of the methods can be performed by system 600 of FIG. 6, system 1000 of FIG. 10, or by another system or device. In another example, one or more of the methods (e.g., process 900, process 1100, process 1200, and/or other methods described herein) can be performed, in whole or in part, by the computing-device architecture 1500 shown in FIG. 15. For instance, a computing device with the computing-device architecture 1500 shown in FIG. 15 can include, or be included in, the components of the system 600 and/or process 1100 and can implement the operations of process 1200, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 900, process 1100, and process 1200, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 900, process 1100, process 1200, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

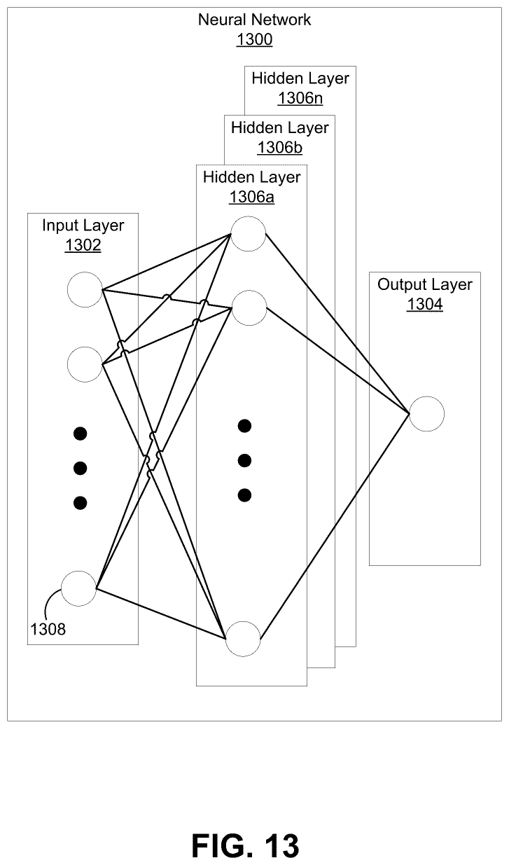

FIG. 13 is an illustrative example of a neural network 1300 (e.g., a deep-learning neural network) that can be used to implement machine-learning based feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 1300 may be an example of, or can implement, gaze estimator 410 of FIG. 4, and/or gaze estimator 602 of FIG. 6 and FIG. 10.

An input layer 1302 includes input data. In one illustrative example, input layer 1302 can include data representing facial images 408 of FIG. 4, FIG. 6, and/or FIG. 10. Neural network 1300 includes multiple hidden layers, for example, hidden layers 1306a, 1306b, through 1306n. The hidden layers 1306a, 1306b, through hidden layer 1306n include “n” number of hidden layers, where “n” is an integer greater than or equal to one. The number of hidden layers can be made to include as many layers as needed for the given application. Neural network 1300 further includes an output layer 1304 that provides an output resulting from the processing performed by the hidden layers 1306a, 1306b, through 1306n. In one illustrative example, output layer 1304 can provide ROI 412 of FIG. 4, FIG. 6, and FIG. 10, and/or ROI 604 of FIG. 6 and FIG. 10.

Neural network 1300 may be, or may include, a multi-layer neural network of interconnected nodes. Each node can represent a piece of information. Information associated with the nodes is shared among the different layers and each layer retains information as information is processed. In some cases, neural network 1300 can include a feed-forward network, in which case there are no feedback connections where outputs of the network are fed back into itself. In some cases, neural network 1300 can include a recurrent neural network, which can have loops that allow information to be carried across nodes while reading in input.

Information can be exchanged between nodes through node-to-node interconnections between the various layers. Nodes of input layer 1302 can activate a set of nodes in the first hidden layer 1306a. For example, as shown, each of the input nodes of input layer 1302 is connected to each of the nodes of the first hidden layer 1306a. The nodes of first hidden layer 1306a can transform the information of each input node by applying activation functions to the input node information. The information derived from the transformation can then be passed to and can activate the nodes of the next hidden layer 1306b, which can perform their own designated functions. Example functions include convolutional, up-sampling, data transformation, and/or any other suitable functions. The output of the hidden layer 1306b can then activate nodes of the next hidden layer, and so on. The output of the last hidden layer 1306n can activate one or more nodes of the output layer 1304, at which an output is provided. In some cases, while nodes (e.g., node 1308) in neural network 1300 are shown as having multiple output lines, a node has a single output and all lines shown as being output from a node represent the same output value.

In some cases, each node or interconnection between nodes can have a weight that is a set of parameters derived from the training of neural network 1300. Once neural network 1300 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 1300 to be adaptive to inputs and able to learn as more and more data is processed.

Neural network 1300 may be pre-trained to process the features from the data in the input layer 1302 using the different hidden layers 1306a, 1306b, through 1306n in order to provide the output through the output layer 1304. In an example in which neural network 1300 is used to identify features in images, neural network 1300 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 1300 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 1300 is trained well enough so that the weights of the layers are accurately tuned.

For the example of identifying objects in images, the forward pass can include passing a training image through neural network 1300. The weights are initially randomized before neural network 1300 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 1300, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 1300 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½(target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 1300 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−η dL/dW, where w denotes a weight, wᵢ denotes the initial weight, and η denotes a learning rate. The learning rate can be set to any suitable value, with a high learning rate including larger weight updates and a lower value indicating smaller weight updates.

Neural network 1300 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 1300 can include any other deep network other than a CNN, such as an autoencoder, a deep belief nets (DBNs), a Recurrent Neural Networks (RNNs), among others.

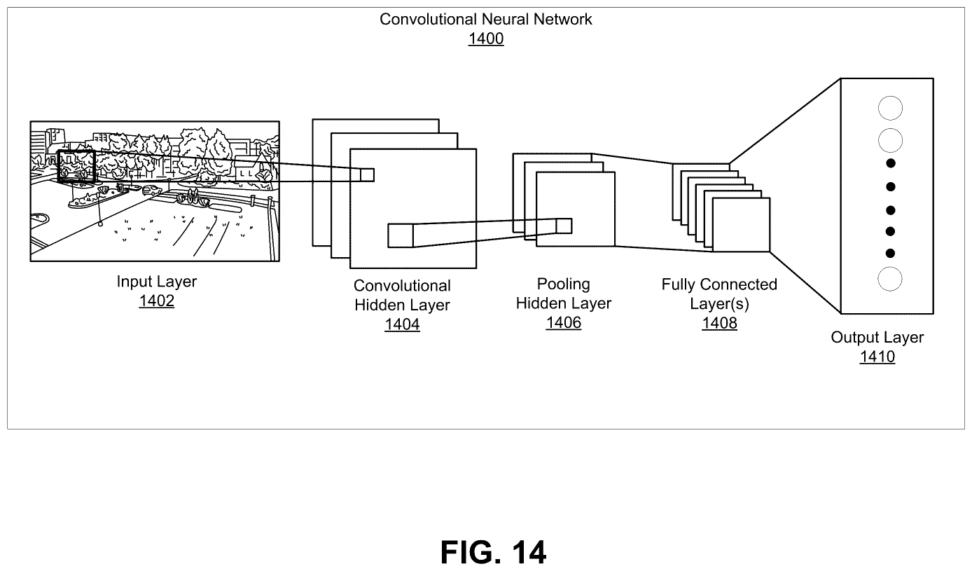

FIG. 14 is an illustrative example of a convolutional neural network (CNN) 1400. The input layer 1402 of the CNN 1400 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1404, an optional non-linear activation layer, a pooling hidden layer 1406, and fully connected layer 1408 (which fully connected layer 1408 can be hidden) to get an output at the output layer 1410. While only one of each hidden layer is shown in FIG. 14, one of ordinary skill will appreciate that multiple convolutional hidden layers, non-linear layers, pooling hidden layers, and/or fully connected layers can be included in the CNN 1400. As previously described, the output can indicate a single class of an object or can include a probability of classes that best describe the object in the image.

The first layer of the CNN 1400 can be the convolutional hidden layer 1404. The convolutional hidden layer 1404 can analyze image data of the input layer 1402. Each node of the convolutional hidden layer 1404 is connected to a region of nodes (pixels) of the input image called a receptive field. The convolutional hidden layer 1404 can be considered as one or more filters (each filter corresponding to a different activation or feature map), with each convolutional iteration of a filter being a node or neuron of the convolutional hidden layer 1404. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1404. Each connection between a node and a receptive field for that node learns a weight and, in some cases, an overall bias such that each node learns to analyze its particular local receptive field in the input image. Each node of the convolutional hidden layer 1404 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 1404 is due to each node of the convolutional layer being applied to its corresponding receptive field. For example, a filter of the convolutional hidden layer 1404 can begin in the top-left corner of the input image array and can convolve around the input image. As noted above, each convolutional iteration of the filter can be considered a node or neuron of the convolutional hidden layer 1404. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1404. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1404.

The mapping from the input layer to the convolutional hidden layer 1404 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1404 can include several activation maps in order to identify multiple features in an image. The example shown in FIG. 14 includes three activation maps. Using three activation maps, the convolutional hidden layer 1404 can detect three different kinds of features, with each feature being detectable across the entire image.

In some examples, a non-linear hidden layer can be applied after the convolutional hidden layer 1404. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1400 without affecting the receptive fields of the convolutional hidden layer 1404.

The pooling hidden layer 1406 can be applied after the convolutional hidden layer 1404 (and after the non-linear hidden layer when used). The pooling hidden layer 1406 is used to simplify the information in the output from the convolutional hidden layer 1404. For example, the pooling hidden layer 1406 can take each activation map output from the convolutional hidden layer 1404 and generates a condensed activation map (or feature map) using a pooling function. Max-pooling is one example of a function performed by a pooling hidden layer. Other forms of pooling functions be used by the pooling hidden layer 1406, such as average pooling, L2-norm pooling, or other suitable pooling functions. A pooling function (e.g., a max-pooling filter, an L2-norm filter, or other suitable pooling filter) is applied to each activation map included in the convolutional hidden layer 1404. In the example shown in FIG. 14, three pooling filters are used for the three activation maps in the convolutional hidden layer 1404.

In some examples, max-pooling can be used by applying a max-pooling filter (e.g., having a size of 2×2) with a stride (e.g., equal to a dimension of the filter, such as a stride of 2) to an activation map output from the convolutional hidden layer 1404. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1404 having a dimension of 24×24 nodes, the output from the pooling hidden layer 1406 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1400.

The final layer of connections in the network is a fully-connected layer that connects every node from the pooling hidden layer 1406 to every one of the output nodes in the output layer 1410. Using the example above, the input layer includes 28 x 28 nodes encoding the pixel intensities of the input image, the convolutional hidden layer 1404 includes 3×24×24 hidden feature nodes based on application of a 5×5 local receptive field (for the filters) to three activation maps, and the pooling hidden layer 1406 includes a layer of 3×12×12 hidden feature nodes based on application of max-pooling filter to 2×2 regions across each of the three feature maps. Extending this example, the output layer 1410 can include ten output nodes. In such an example, every node of the 3×12×12 pooling hidden layer 1406 is connected to every node of the output layer 1410.

The fully connected layer 1408 can obtain the output of the previous pooling hidden layer 1406 (which should represent the activation maps of high-level features) and determines the features that most correlate to a particular class. For example, the fully connected layer 1408 can determine the high-level features that most strongly correlate to a particular class and can include weights (nodes) for the high-level features. A product can be computed between the weights of the fully connected layer 1408 and the pooling hidden layer 1406 to obtain probabilities for the different classes. For example, if the CNN 1400 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1410 can include an M-dimensional vector (in the prior example, M=10). M indicates the number of classes that the CNN 1400 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 15 illustrates an example computing-device architecture 1500 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1500 may include, implement, or be included in any or all of system 600 of FIG. 6, system 1000 of FIG. 10, and/or other devices, modules, or systems described herein. Additionally or alternatively, computing-device architecture 1500 may be configured to perform process 900, process 1100, process 1200, and/or other process described herein.

The components of computing-device architecture 1500 are shown in electrical communication with each other using connection 1512, such as a bus. The example computing-device architecture 1500 includes a processing unit (CPU or processor) 1502 and computing device connection 1512 that couples various computing device components including computing device memory 1510, such as read only memory (ROM) 1508 and random-access memory (RAM) 1506, to processor 1502.

Computing-device architecture 1500 can include a cache of high-speed memory connected directly with, in close proximity to, or integrated as part of processor 1502. Computing-device architecture 1500 can copy data from memory 1510 and/or the storage device 1514 to cache 1504 for quick access by processor 1502. In this way, the cache can provide a performance boost that avoids processor 1502 delays while waiting for data. These and other modules can control or be configured to control processor 1502 to perform various actions. Other computing device memory 1510 may be available for use as well. Memory 1510 can include multiple different types of memory with different performance characteristics. Processor 1502 can include any general-purpose processor and a hardware or software service, such as service 1 1516, service 2 1518, and service 3 1520 stored in storage device 1514, configured to control processor 1502 as well as a special-purpose processor where software instructions are incorporated into the processor design. Processor 1502 may be a self-contained system, containing multiple cores or processors, a bus, memory controller, cache, etc. A multi-core processor may be symmetric or asymmetric.

To enable user interaction with the computing-device architecture 1500, input device 1522 can represent any number of input mechanisms, such as a microphone for speech, a touch-sensitive screen for gesture or graphical input, keyboard, mouse, motion input, speech and so forth. Output device 1524 can also be one or more of a number of output mechanisms known to those of skill in the art, such as a display, projector, television, speaker device, etc. In some instances, multimodal computing devices can enable a user to provide multiple types of input to communicate with computing-device architecture 1500. Communication interface 1526 can generally govern and manage the user input and computing device output. There is no restriction on operating on any particular hardware arrangement and therefore the basic features here may easily be substituted for improved hardware or firmware arrangements as they are developed.

Storage device 1514 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 1506, read only memory (ROM) 1508, and hybrids thereof. Storage device 1514 can include services 1516, 1518, and 1520 for controlling processor 1502. Other hardware or software modules are contemplated. Storage device 1514 can be connected to the computing device connection 1512. In one aspect, a hardware module that performs a particular function can include the software component stored in a computer-readable medium in connection with the necessary hardware components, such as processor 1502, connection 1512, output device 1524, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for processing image data, the apparatus comprising: at least one memory; and at least one processor coupled to the at least one memory and configured to: determine a first region of interest (ROI) for first image data based on gaze data; provide an indication of the first ROI to an image processor; process, using the image processor, the first image data based on the first ROI; predict a second ROI for second image data based on the gaze data; provide an indication of the second ROI to an image sensor; and capture, using the image sensor, the second image data based on the second ROI.

Aspect 2. The apparatus of aspect 1, wherein the first image data is captured by the image sensor and provided to the image processor prior to the second image data being captured by the image sensor.

Aspect 3. The apparatus of any one of aspects 1 or 2, wherein the first ROI is smaller than the second ROI.

Aspect 4. The apparatus of any one of aspects 1 to 3, wherein, to process the first image data based on the first ROI, the at least one processor is configured to fetch the first image data from memory based on the first ROI.

Aspect 5. The apparatus of aspect 4, wherein, to fetch the first image data from the memory based on the first ROI, the at least one processor is configured to fetch a subset of ROI image data available in the memory.

Aspect 6. The apparatus of any one of aspects 1 to 5, wherein, to process the first image data based on the first ROI, the at least one processor is configured to process ROI image data within the first ROI at a higher resolution than non-ROI image data outside the first ROI.

Aspect 7. The apparatus of any one of aspects 1 to 6, wherein the image processor comprises a first image processor, wherein the at least one processor is further configured to: provide the indication of the first ROI to a second image processor; and process, using the second image processor, third image data based on the first ROI.

Aspect 8. The apparatus of any one of aspects 1 to 7, wherein the gaze data comprises first gaze data, wherein the at least one processor is further configured to: determine a third ROI for third image data based on second gaze data; provide an indication of the third ROI to the image processor; process, using the image processor, the third image data based on the third ROI; predict a fourth ROI for fourth image data based on the second gaze data; provide an indication of the fourth ROI to the image sensor; and capture, using the image sensor, the fourth image data based on the fourth ROI.

Aspect 9. A method for processing image data, the method comprising: determining a first region of interest (ROI) for first image data based on gaze data; providing an indication of the first ROI to an image processor; processing, using the image processor, the first image data based on the first ROI; predicting a second ROI for second image data based on the gaze data; providing an indication of the second ROI to an image sensor; and capturing, using the image sensor, the second image data based on the second ROI.

Aspect 10. The method of aspect 9, wherein the first image data is captured by the image sensor and provided to the image processor prior to the second image data being captured by the image sensor.

Aspect 11. The method of any one of aspects 9 or 10, wherein the first ROI is smaller than the second ROI.

Aspect 12. The method of any one of aspects 9 to 11, wherein processing the first image data based on the first ROI comprises fetching the first image data from memory based on the first ROI.

Aspect 13. The method of aspect 12, wherein fetching the first image data from the memory based on the first ROI comprises fetching a subset of ROI image data available in the memory.

Aspect 14. The method of any one of aspects 9 to 13, wherein processing the first image data based on the first ROI comprises processing ROI image data within the first ROI at a higher resolution than non-ROI image data outside the first ROI.

Aspect 15. The method of any one of aspects 9 to 14, wherein the image processor comprises a first image processor, the method further comprising: providing the indication of the first ROI to a second image processor; and processing, using the second image processor, third image data based on the first ROI.

Aspect 16. The method of any one of aspects 9 to 15, wherein the gaze data comprises first gaze data, the method further comprising: determining a third ROI for third image data based on second gaze data; providing an indication of the third ROI to the image processor; processing, using the image processor, the third image data based on the third ROI; predicting a fourth ROI for fourth image data based on the second gaze data; providing an indication of the fourth ROI to the image sensor; and capturing, using the image sensor, the fourth image data based on the fourth ROI.

Aspect 17. A non-transitory computer-readable storage medium having stored thereon instructions that, when executed by at least one processor, cause the at least one processor to: determine a first region of interest (ROI) for first image data based on gaze data; provide an indication of the first ROI to an image processor; process, using the image processor, the first image data based on the first ROI; predict a second ROI for second image data based on the gaze data; provide an indication of the second ROI to an image sensor; and capture, using the image sensor, the second image data based on the second ROI.

Aspect 18. The non-transitory computer-readable storage medium of aspect 17, wherein the first image data is captured by the image sensor and provided to the image processor prior to the second image data being captured by the image sensor.

Aspect 19. The non-transitory computer-readable storage medium of any one of aspects 17 or 18, wherein the first ROI is smaller than the second ROI.

Aspect 20. The non-transitory computer-readable storage medium of any one of aspects 17 to 19, wherein, to process the first image data based on the first ROI, the instructions, when executed by at least one processor, cause the at least one processor to fetch the first image data from memory based on the first ROI.

Aspect 21. The non-transitory computer-readable storage medium of aspect 20, wherein, to fetch the first image data from the memory based on the first ROI, the at least one processor is configured to fetch a subset of ROI image data available in the memory.

Aspect 22. The non-transitory computer-readable storage medium of any one of aspects 17 to 21, wherein, to process the first image data based on the first ROI, the at least one processor is configured to process ROI image data within the first ROI at a higher resolution than non-ROI image data outside the first ROI.

Aspect 23. The non-transitory computer-readable storage medium of any one of aspects 17 to 22, wherein the image processor comprises a first image processor, wherein the at least one processor is further configured to: provide the indication of the first ROI to a second image processor; and process, using the second image processor, third image data based on the first ROI.

Aspect 24. The non-transitory computer-readable storage medium of any one of aspects 17 to 23, wherein the gaze data comprises first gaze data, wherein the at least one processor is further configured to: determine a third ROI for third image data based on second gaze data; provide an indication of the third ROI to the image processor; process, using the image processor, the third image data based on the third ROI; predict a fourth ROI for fourth image data based on the second gaze data; provide an indication of the fourth ROI to the image sensor; and capture, using the image sensor, the fourth image data based on the fourth ROI.

Aspect 25. An apparatus for providing virtual content for display, the apparatus comprising one or more means for perform operations according to any of aspects 9 to 16.

What is claimed is:

1. An apparatus for processing image data, the apparatus comprising:
at least one memory; and
at least one processor coupled to the at least one memory and configured to:
determine a first region of interest (ROI) for first image data based on gaze data;
provide an indication of the first ROI to an image processor;
process, using the image processor, the first image data based on the first ROI;
predict a second ROI for second image data based on the gaze data;
provide an indication of the second ROI to an image sensor; and
capture, using the image sensor, the second image data based on the second ROI.

2. The apparatus of claim 1, wherein the first image data is captured by the image sensor and provided to the image processor prior to the second image data being captured by the image sensor.

3. The apparatus of claim 1, wherein the first ROI is smaller than the second ROI.

4. The apparatus of claim 1, wherein, to process the first image data based on the first ROI, the at least one processor is configured to fetch the first image data from memory based on the first ROI.

5. The apparatus of claim 4, wherein, to fetch the first image data from the memory based on the first ROI, the at least one processor is configured to fetch a subset of ROI image data available in the memory.

6. The apparatus of claim 1, wherein, to process the first image data based on the first ROI, the at least one processor is configured to process ROI image data within the first ROI at a higher resolution than non-ROI image data outside the first ROI.

7. The apparatus of claim 1, wherein the image processor comprises a first image processor, wherein the at least one processor is further configured to:
provide the indication of the first ROI to a second image processor; and
process, using the second image processor, third image data based on the first ROI.

8. The apparatus of claim 1, wherein the gaze data comprises first gaze data, wherein the at least one processor is further configured to:
determine a third ROI for third image data based on second gaze data;
provide an indication of the third ROI to the image processor;
process, using the image processor, the third image data based on the third ROI;
predict a fourth ROI for fourth image data based on the second gaze data;
provide an indication of the fourth ROI to the image sensor; and
capture, using the image sensor, the fourth image data based on the fourth ROI.

9. A method for processing image data, the method comprising:
determining a first region of interest (ROI) for first image data based on gaze data;
providing an indication of the first ROI to an image processor;
processing, using the image processor, the first image data based on the first ROI;
predicting a second ROI for second image data based on the gaze data;
providing an indication of the second ROI to an image sensor; and
capturing, using the image sensor, the second image data based on the second ROI.

10. The method of claim 9, wherein the first image data is captured by the image sensor and provided to the image processor prior to the second image data being captured by the image sensor.

11. The method of claim 9, wherein the first ROI is smaller than the second ROI.

12. The method of claim 9, wherein processing the first image data based on the first ROI comprises fetching the first image data from memory based on the first ROI.

13. The method of claim 12, wherein fetching the first image data from the memory based on the first ROI comprises fetching a subset of ROI image data available in the memory.

14. The method of claim 9, wherein processing the first image data based on the first ROI comprises processing ROI image data within the first ROI at a higher resolution than non-ROI image data outside the first ROI.

15. The method of claim 9, wherein the image processor comprises a first image processor, the method further comprising:
providing the indication of the first ROI to a second image processor; and
processing, using the second image processor, third image data based on the first ROI.

16. The method of claim 9, wherein the gaze data comprises first gaze data, the method further comprising:
determining a third ROI for third image data based on second gaze data;
providing an indication of the third ROI to the image processor;
processing, using the image processor, the third image data based on the third ROI;
predicting a fourth ROI for fourth image data based on the second gaze data;
providing an indication of the fourth ROI to the image sensor; and
capturing, using the image sensor, the fourth image data based on the fourth ROI.

17. A non-transitory computer-readable storage medium having stored thereon instructions that, when executed by at least one processor, cause the at least one processor to:
determine a first region of interest (ROI) for first image data based on gaze data;
provide an indication of the first ROI to an image processor;
process, using the image processor, the first image data based on the first ROI;
predict a second ROI for second image data based on the gaze data;
provide an indication of the second ROI to an image sensor; and
capture, using the image sensor, the second image data based on the second ROI.

18. The non-transitory computer-readable storage medium of claim 17, wherein the first image data is captured by the image sensor and provided to the image processor prior to the second image data being captured by the image sensor.

19. The non-transitory computer-readable storage medium of claim 17, wherein the first ROI is smaller than the second ROI.

20. The non-transitory computer-readable storage medium of claim 17, wherein, to process the first image data based on the first ROI, the instructions, when executed by at least one processor, cause the at least one processor to fetch the first image data from memory based on the first ROI.
